(19) United States
(12) Patent Application Publication
(10) Pub. No.: US 2025/0200086 A1
(43) Pub. Date: Jun. 19, 2025

(54) COMMUNICATION NETWORK MANAGEMENT USING GENERATIVE LARGE LANGUAGE MODEL

(71) Applicant: AT&T Intellectual Property I, L.P., Atlanta, GA (US)

(72) Inventors: Mehdi Malboubi, San Ramon, CA (US); Weihua Ye, Chicago, IL (US); Usama Masood, San Ramon, CA (US); Jin Wang, Fremont, CA (US); Raghvendra Savoor, Walnut Creek, CA (US)

(21) Appl. No.: 18/389,706

(22) Filed: Dec. 19, 2023

(51) Int. Cl. G06F 16/33; G06F 40/40

(52) U.S. Cl. CPC G06F 16/334; G06F 40/40

(57) ABSTRACT

A processing system including at least one processor may obtain network operational data of a communication network, transform the network operational data into a text-based format, and train a generative machine learning model implemented by the processing system using the network operational data in the text-based format. The processing system may then receive a query pertaining to the network operational data, apply the query to the generative machine learning model implemented by the processing system to generate a textual output in response to the query, and present the textual output that is generated in response to the query.

The present disclosure relates generally to communication network operations, and more specifically to methods, computer-readable media, and apparatuses for presenting in response to a query a textual output of a generative machine learning model trained using network operational data that is transformed into a text-based format.

### BACKGROUND

In data communication networks, protocols serve as a common language for devices/systems to communicate irrespective of differences in software, hardware, or internal processes. A large communication network may collect and process a substantial volume of data generated by devices/systems following such protocols. Such data may be primarily maintained in database tables, e.g., in a structured query language (SQL) or no-SQL format. In addition, tables, or rows and columns thereof may be associated or linked to one another to maintain additional knowledge in a graph database, and so forth. In addition, graph databases are useful for structuring large amounts of interconnected data and provide flexibility to impose rules on relationships and attributes. In some cases, data may be structured in a tree-based graph. For instance, this approach may be useful when the data has hierarchical relationships, providing the ability to easily and efficiently retrieve data from graph databases.

### SUMMARY

The present disclosure describes methods, computer-readable media, and apparatuses for presenting in response to a query a textual output of a generative machine learning model trained using network operational data that is transformed into a text-based format. For instance, in one example, a processing system including at least one processor may obtain network operational data of a communication network, transform the network operational data into a text-based format, and train a generative machine learning model implemented by the processing system using the network operational data in the text-based format. The processing system may then receive a query pertaining to the network operational data, apply the query to the generative machine learning model implemented by the processing system to generate a textual output in response to the query, and present the textual output that is generated in response to the query.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates an example system for presenting in response to a query a textual output of a generative machine learning model trained using network operational data that is transformed into a text-based format, in accordance with the present disclosure;

FIG. 3 illustrates an example flowchart that may be converted to a text-based format and used for training a generative machine learning model of the present disclosure;

FIG. 4 illustrates an example flowchart of a method for presenting in response to a query a textual output of a generative machine learning model trained using network operational data that is transformed into a text-based format; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for presenting in response to a query a textual output of a generative machine learning model trained using network operational data that is transformed into a text-based format. In particular, examples of the present disclosure describe an intelligent, data-driven generation of knowledge/awareness in a communication network through converting of network operational data (e.g., network measurements, computed performance indicators (e.g., “key performance indicators” (KPIs)), associated configurations/parameters, etc.) into text or other media formats to directly and adaptively train and tune a generative artificial intelligence (AI)/machine learning (ML) model, such as a deep neural network comprising a large language model (LLM), using the converted network operational data. For illustrative purposes suitable AI/ML models of this nature may be referred to herein as a generative machine learning model (MLM), an example of which may comprise a generative AI/LLM (Gen-AI/LLM). In one example, the present disclosure may further incorporate textual auxiliary information from various sources internal and/or external to the communication network. Accordingly, the generative MLM may be trained to understand/comprehend the inherent language of the underlying communication protocols in use in the communication network, to identify long-term dependencies and correlations between data for various applications, such as for answering questions, for predictive inference/analysis, and so forth. In this way, the generative MLM can learn from the network operational data in the context of knowledge ingested from auxiliary data-sources/documents to provide enhanced insight into the network operational data in a timely manner.

A large language model (LLM) is an advanced type of deep learning AI/ML model that uses massively large data sets to understand, summarize, generate and predict new content. In data communication networks, protocols serve as a common language for devices to enable communication, irrespective of differences in software, hardware, or internal processes. A large communication network operator may process a tremendous volume of numeric network operational data in (e.g., network measurements and performance indicators, configuration settings/parameters, etc.) generated by devices following such protocols. Such data is typically stored in table form. Even in a graph database structure, the underlying data may still be found in vector and table-based records.

In addition, a large communication network operator may possess a vast knowledge-base of documents containing valuable data/information for network design, deployment, optimization, troubleshooting, and so forth that may further improve the performance of a generative MLM of the present disclosure in various applications. Accordingly, examples of the present disclosure may enable network personnel or other automated systems to more quickly obtain actionable information using such a generative MLM for one or more of these purposes in managing the network. In addition, in one example, external users or automated entities may be provided with usage of such a generative MLM, e.g., without the concerns of having direct access to the original data. In addition, a network management platform of the present disclosure including a generative MLM may be instantiated on private and/or public cloud infrastructure or may be deployed at the network edge (e.g., in an access network portion of the communication network) for use by internal/external users or automated entities for different applications, such as, question/answering, summarization, predictive analysis/forecasting, anomaly detection and alerting, or the like.

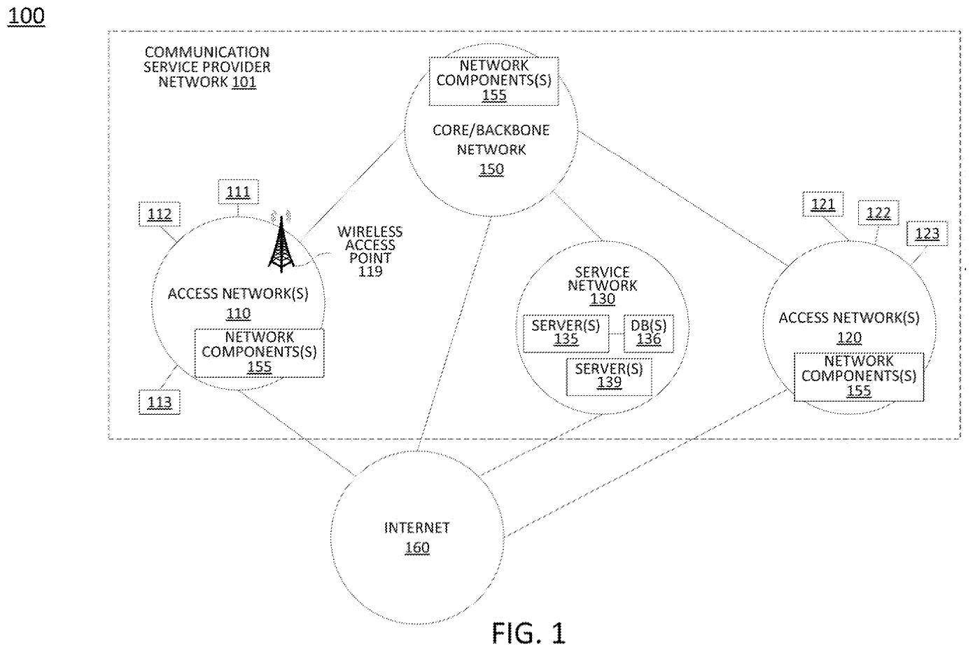

It should be noted that LLM-based models are primarily trained using text-based data. In accordance with the present disclosure, numeric data (e.g., network measurements, computed KPIs, and associated parameters/configuration settings stored in databases, files, etc. and/or obtained in real-time or near-real-time (e.g., as soon as practicable according to the ability of a data streaming pipeline)) may be transformed/converted into text (or other media formats, such as images) to directly train a generative MLM (e.g., a Gen-AI/LLM model, or the like) with the converted data, along with auxiliary documents/data from other sources. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or video services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access networks 110 and 120 may each comprise a Digital Subscriber Line (DSL) network, a broadband cable access network, a Local Area Network (LAN), a cellular or non-cellular wireless access network, and the like. For example, access networks 110 and 120 may transmit and receive communications between endpoint devices 111-113, endpoint devices 121-123, and service network 130, and between core/backbone network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. In another example, one or both of the access networks 110 and 120 may comprise an ISP network external to communication service provider network 101, such that endpoint devices 111-113 and/or 121-123 may communicate over the Internet 160, without involvement of the communication service provider network 101. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, a set-top box (STB).

In one example, the access networks 110 and 120 may be different types of access networks. In another example, the access networks 110 and 120 may be the same type of access network. In one example, one or more of the access networks 110 and 120 may be operated by the same or a different service provider from a service provider operating the communication service provider network 101. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home or enterprise gateway and/or router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, communication service provider network 101 may also include one or more network components 155 (e.g., in core/backbone network 150 and/or access network(s) 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an Internet exchange point (IXP) switch, and so on. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. In addition, for ease of illustration, various components of communication service provider network 101 are omitted from FIG. 1.

Still other network components 155 may include a database of assigned telephone numbers, a database of basic customer account information for all or a portion of the customers/subscribers of the communication service provider network 150, a cellular network service home location register (HLR), e.g., with current serving base station information of various subscribers, and so forth, a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components 155 may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner.

In accordance with the present disclosure, network components 155 may comprise “network resources” of various network resource types, which may also include services provided and/or hosted via network components 155, e.g., enterprise communication services, such as a virtual private network (VPN) service, a virtual local area network (VLAN) service, a Voice over Internet Protocol (VoIP), a software defined-wide area network (SD-WAN) service, an Ethernet wide area network E-WAN service, and so forth. Alternatively, or in addition, network resources may include interfaces or ports associated with such services, such as a customer edge (CE) router or PBX-to-time division multiplexing (TDM) gateway interface, a Border Gateway Protocol (BGP) interface (e.g., between BGP peers), and so forth. For instance, a CE router, PBX, or the like may be homed to one or several provider edge (PE) routers or other edge component(s).

In one example, the service network 130 may comprise a local area network (LAN), or a distributed network connected through permanent virtual circuits (PVCs), virtual private networks (VPNs), and the like for providing data and voice communications. In one example, the service network 130 may comprise one or more devices for providing services to subscribers, customers, and/or users. For example, communication service provider network 101 may provide a cloud storage service, web server hosting, and other services. As such, service network 130 may represent aspects of communication service provider network 101 where infrastructure for supporting such services may be deployed. In one example, the service network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, a network inventory system, a network provisioning system, a unified data repository (UDR), and so forth. In one example, server(s) 139 may alternatively or additionally comprise one or more of the types of network components 155 described above.

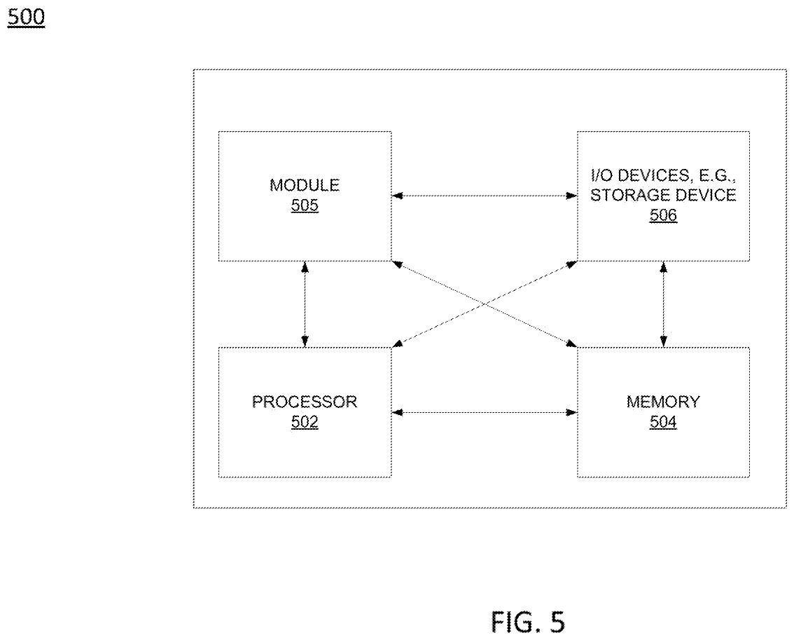

In addition, service network 130 may include one or more servers 135 which may each comprise all or a portion of a computing device or system, such as computing system 500, and/or processing system 502 as described in connection with FIG. 5 below, specifically configured to perform various steps, functions, and/or operations for presenting in response to a query a textual output of a generative machine learning model trained using network operational data that is transformed into a text-based format, as described herein. For example, one of the server(s) 135, or a plurality of the servers 135 collectively, may perform operations in connection with the example method 400, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. For example, DB(s) 136 may be configured to receive and store network operational data, including information on the type(s) of network resources, utilization and/or availability levels of such network resources, configuration settings and/or parameters of such network resources, alarm data, and so forth. It should be noted that some or all of such information may be contained in other network databases/systems, such as one or more of an active and available inventory (A&AI) database, a network inventory database, a call detail records (CDR) repository, or the like (e.g., represented by server(s) 139 and/or various network components 155). Alternatively, or in addition, DB(s) 136 may be configured to receive and store customer/subscriber network resource order information (e.g., an additional type or types of network operational data), such as the subscriber/customer identities and other characteristics (e.g., a customer intensity value and/or a customer segment as described herein), the timing of such orders, the quantities of such orders, the type of service(s) ordered, and so forth. Similar to the above, some or all of such information may be contained in other network databases/systems, such as one or more of an authentication, authorization, and accounting (AAA) server/system, an operations support system (OSS), a business support system (BSS), a unified data repository (UDR), or the like.

It should be noted that in accordance with the present disclosure, the network operational data stored in DB(s) 136 or elsewhere may be maintained over a period of time. For instance, DB(s) 136 may store respective time series data indicative of different utilization and/or assignment levels of various network resources of various types in a given time interval (and over a period of a plurality of time intervals), etc. In one example, data may be segregated by customer segment, network zone, geographic region, and so forth.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a generative MLM-based communication network knowledge platform (e.g., a network-based and/or cloud-based service hosted on the hardware of server(s) 135 and/or DB(s) 136).

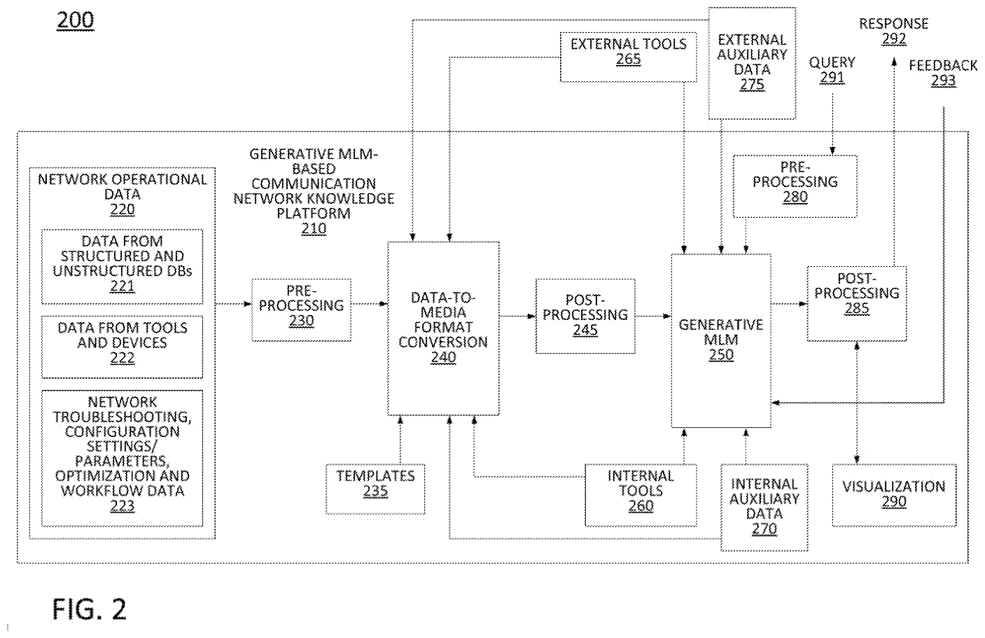

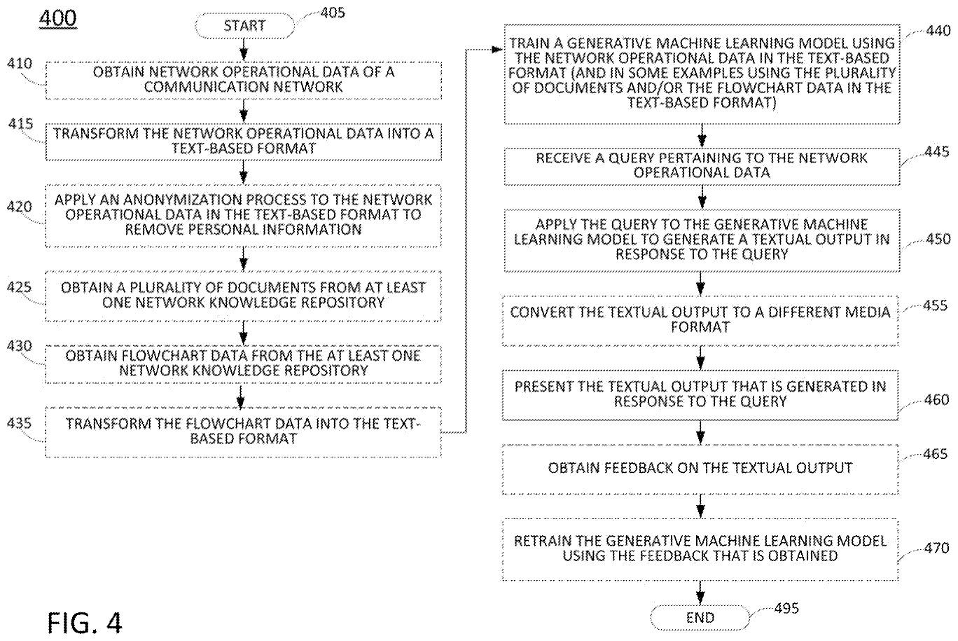

As noted above, server(s) 135 may be configured to perform various steps, functions, and/or operations for presenting in response to a query a textual output of a generative machine learning model trained using network operational data that is transformed into a text-based format, as described herein. For instance, an example method for presenting in response to a query a textual output of a generative machine learning model trained using network operational data that is transformed into a text-based format is illustrated in FIG. 4 and described in greater detail below. To further illustrate, server(s) 135 may obtain network operational data, e.g., from DB(s) 136 and/or from one or more other data repositories of communication network 101. The network operational data may include network performance indicator data and/or configurable setting values for one or more network settings e.g., KPIs or other measurements self-reported by devices or measured by other entities within the network. Server(s) 135 may next transform the network operational data into a text-based format and train a generative machine learning model (MLM) using the network operational data in the text-based format. In one example, server(s) 135 may further obtain documents such as whitepapers, technical manuals, training materials, etc. and/or flowchart data (e.g., relating to network operations) from a network knowledge repository (which may also be transformed into a text-based format). In such an example, the training of the generative MLM may further utilize the documents and/or transformed flowchart information as additional training data. Server(s) 135 may next receive a query pertaining to the network operational data. To illustrate, the query be received from a user via a user endpoint device. For instance, the order may be obtained from one of the endpoint devices 111-113 or 121-123. In another example, the query may be received from another automated system, such as a software defined network (SDN) controller, a self-optimizing network (SON) orchestrator, an alarm/alerting system, an intrusion detection system, or the like (which may be represented by server(s) 139, various network components 155, or the like in FIG. 1). In various examples, the query may comprise a classification request, a summarization request, a question pertaining to the network operational data, a prediction and/or forecasting request, an anomaly detection and/or root cause analysis request, a network setting recommendation request, or the like. Server(s) 135 may apply the query to the generative MLM to generate a textual output in response to the query. Server(s) 135 may then present the textual output that is generated in response to the query, e.g., to one of the endpoint devices 111-113 or 121-123 or to server(s) 139, one of network components 155, or the like. Servers(s) 135 may alternatively or additionally perform various operations as described in connection with FIGS. 2-5, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of the server(s) 135 and DB(s) 136 may be distributed at different locations, such as in or connected to access networks 110 and 120, in another service network connected to Internet 160 (e.g., a cloud computing provider), in core/backbone network 150, and so forth. Thus, these and other modifications are all contemplated within the scope of the present disclosure.

FIG. 2 illustrates an example system 200 for presenting in response to a query a textual output of a generative machine learning model trained using network operational data that is transformed into a text-based format, in accordance with the present disclosure. In particular, the system 200 includes a generative MLM-based communication network knowledge platform 210 which in one example may further utilize external tools 265 and external auxiliary data 275, as described in greater detail below. In one example, the generative MLM-based communication network knowledge platform 210 may perform the same or similar operations as server(s) 135 described above, or vice versa. In one example, the generative MLM-based communication network knowledge platform 210 may primarily derive network knowledge from network operational data 220. For instance, the network operational data 220 may include data from structured and unstructured databases (DBs) 221, such as one or more structured query language (SQL) databases, graph databases, databases with time series data, etc. In one example, the network operational data 220 may further include data from tools and devices 222, such as route reflectors, customer gateways, etc. Alternatively, or in addition, the network operational data 220 may include network troubleshooting data, configuration settings/parameters of various devices, systems, services, or the like in the communication network, optimization and workflow data 223. It should be noted that the present examples of network operational data 220 are provided by way of illustration only. Thus, it should be appreciated that examples of the present disclosure are not limited to any particular type of network operational data or sub-categorizations of such network operational data.

In one example, the network operational data 220 may be ingested and converted to a text-based format via data-to-media format conversion module 240. In one example, the network operational data 220 may be pre-processed via module 230. For instance, this may include extract, transform, and load (ETL) operations, data cleaning and/or sanitizing operations, aggregation, averaging, smoothing, anonymization, and so forth. In one example, the data-to-media format conversion module 240 may transform primarily numeric, table-based data into a text-based format using one or more templates 235. For instance, data-to-media format conversion module 240 may comprise at least one artificial intelligence (AI) model that is configured to transform the network operational data into the text-based format. For instance, the at least one AI model may comprise at least one machine learning model (MLM) that is trained to transform the network operational data into the text-based format. In one example, the at least one MLM may be trained along with the primary generative MLM 250, e.g., based upon user feedback or other objective criteria over which the system 200 and/or the generative MLM-based communication network knowledge platform 210 as a whole may be optimized. In another example, the at least one MLM may be separately trained for such task. Alternatively, or in addition, the at least one AI model may implement one or more rule-based algorithms to convert tabular data or the like into text format. For instance, templates 235 may represent such rule-based algorithms that may be implemented via the data-to-media format conversion module 240. In one example, within a given AI model there may be different rules for different types of data. Similarly, in one example there may be different AI models for different data types. In one example, the data-to-media format conversion module 240 may select the at least one AI model from among the plurality of AI models based upon a performance optimization criteria of the generative MLM 250, e.g., an AI model that produces transformed text resulting in superior performance metric(s) for the generative MLM 250. In one example, the data-to-media format conversion module 240 may also select different AI models for different data types in this manner. In one example, this may be performed as a reinforcement learning (RL) process.

In one example, the data-to-media format conversion module 240 may also ingest internal auxiliary data 270 and/or external auxiliary data 275 for conversion to a text-based format. For instance, as noted above, there may be flowcharts or the like which may be converted into text-based format. Other internal auxiliary data 270 and/or external auxiliary data 275 may already be in text-based format and may be used without format conversion as inputs (e.g., training data for the generative MLM 250), such as internal technical documents, tools descriptions, etc., external technical documents, scientific papers, books, web-data, and so forth. In one example, the quality of results of the data-to-media format conversion module 240 may be further enhanced via the use of internal tools 260 and/or external tools 265 (e.g., a different LLM-based generative MLM, such as a general purpose LLM-based generative MLM or a different AI/MLM-based system of the communication network in which the generative MLM-based communication network knowledge platform 210 is deployed). Thus, it should be noted that for each data source, there may be multiple ways to accomplish the conversion, where the optimal conversion can be obtained in an adaptive manner and based on the application and the ultimate performance criteria that may be selected (e.g., accuracy, speed, a balance of such factors, etc.). In any case, the data-to-media format conversion module 240 may output the network operational data 220 in a text-based format (and in one example, may further output internal auxiliary data 270 and/or external auxiliary data 275 that have been converted into a text-based format).

In one example, post-processing 245 may be applied to the output text-based data from the data-to-media format conversion module 240. For instance, this may include data cleaning and/or sanitizing operations, aggregation, averaging, smoothing, anonymization, and so forth. For example, a zip code contained in database table entry may be represented as a city and state in the text-based format. For instance, a customer ID may have been transformed into a user name “John Smith” in the text-based format. However, it may be possible for the generative MLM 250 to return privacy-compromising results in response to particular queries about particular users if the users' names are directly associated with the respective training data. As such, the user name “John Smith” may be replaced by a customer segment (e.g., “prepaid customer,” “post-paid customer,” “enterprise customer,” “governmental customer,” etc.) or an anonymized identifier (e.g., “enterprise customer 317B2” or the like). Other post-processing may include converting timestamp to data-time text, converting quantitative data to qualitative texts (e.g., numeric data can be converted to low/medium/high levels by comparing with appropriate thresholds), and so forth. Other post-processing adjustments may be made with respect to specific street addresses, income levels, credit card information, etc. depending upon the nature of the underlying network operational data, the particular query and the relevant information that is sought, and so on.

In one example, the generative MLM 250 may comprise a trained machine learning algorithm. For instance, a machine learning algorithm (MLA), or machine learning model (MLM) trained via a MLA may comprise a deep learning neural network, or deep neural network (DNN), a recurrent neural network (RNN), a convolutional neural network (CNN), a generative adversarial network (GAN), a decision tree algorithms/models, such as gradient boosted decision tree (GBDT) (e.g., XGBoost, or the like), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

In one example, the generative MLM 250 may comprise a language model-based MLM, e.g., a large language model (LLM)-based MLM. For instance, in accordance with the present disclosure, generative MLM 250 may comprise a generative pre-trained transformer (GPT) model, a Large Language Model Meta AI (LLaMA) model, a Language Model for Dialogue Applications (LaMDA) model, a Pathways Language Model (PaLM) model, a bidirectional transformer that is pre-trained for language understanding/natural language processing (NLP) tasks (e.g., a Bidirectional Encoder Representations from Transformers (BERT) model), and so forth. In one example, the generative MLM 250 may include a mixture of experts or ensemble of multiple base MLMs. In accordance with the present disclosure, the generative MLM 250 may be trained with the data converted to text e.g., from multiple sources of network operational data 220. In one example, the generative MLM 250 may be further trained with internal auxiliary data 270 and/or external auxiliary data 275, which may be converted to a text-based format, e.g., via data-to-media format conversion module 240 or which may have a native text-based format and be ingested for training the generative MLM 250 without conversion (and/or with data cleansing, sanitizing, anonymization, etc. applied at post-processing 245, for instance). In one example, different MLMs may be possessed by the generative MLM-based communication network knowledge platform 210, where based on the accuracy/quality of the response/output these MLMs can be reconfigured/retrained in an adaptive way. As such, in one example, the generative MLM 250 may comprise one or more MLMs that is/are selected via an auto-ML process. For instance, an operator may provide optimization criteria to obtain the best performing model with respect to accuracy, speed, a combination of such factors, etc. In addition, in one example, the generative MLM 250 may be adapted from a pre-trained model, where the framework of the generative MLM-based communication network knowledge platform 210 may be used to modify and retune the adopted model(s). Thus, it should be noted that training of the generative MLM 250 can be accomplished in different ways such as training from scratch, fine-tuning of a pre-trained model, retrieval-augmented generation (RAG), reinforcement learning using feedback, prompting/prompt-tuning, learning using adapters, a combination of any of the foregoing, and so forth. To improve the accuracy and/or other performance aspects of the generative MLM 250, in one example feedback 293 (e.g., from a user or other automated systems) may be applied to the generative MLM 250. In one example, the generative MLM 250 may be benchmarked using internal tools 260 and/or external tools 265 to reduce the inaccuracy and improve the performance of the generative MLM 250.

Notably, the network operational data 220 reflects the inherent language of the underlying communication protocols used in the communication network. Accordingly, the generative MLM 250 may identify long-term dependencies and correlations between data. In addition, in one example, the generative MLM 250 may learn from the network operational data 220 in the context of additional knowledge from internal auxiliary data 270 and/or external auxiliary data 275, and may provide improved insight into the network operational data 220 in a timely manner. For instance, in one example, the generative MLM 250 may learn to identify various anomalies and/or root-causes with higher accuracy and/or speed. For example, the generative MLM 250 may identify missed, dropped, failed or out-of-order messages in a sequence of messages that is required to accomplish a certain task in the communication networks based on certain protocols. Detection of such patterns may alternatively or additionally relate to security breaches, attacks against the network, or the like.

A user can interact with the generative MLM-based communication network knowledge platform 210/generative MLM 250, e.g., after proper authentication and authorization. Alternatively, or in addition, one or more other automated systems may similarly interact with the generative MLM-based communication network knowledge platform 210/generative MLM 250. For instance, a user or automated entity may submit a query 291, e.g., a request, to the generative MLM-based communication network knowledge platform 210. In one example, the query may be in a text-based and/or natural language format. As noted above, the query 291 may comprise a classification request, a summarization request, a question pertaining to the network operational data, a forecasting request, an anomaly detection request, a network setting recommendation request, or the like. In one example, pre-processing 280 may also be applied to the query 291, for example, by removing unnecessary words, converting the query 291 into a proper format for the framework which optimizes the performance, etc. The output of the generative MLM 250, e.g., response, predictions, etc. can be represented to the requesting user or automated entity after applying post-processing 285, such as anonymization and encryption, etc. In one example, the output of the generative MLM 250 may be in text-based format as described in greater detail below.

In one example, the output of the generative MLM 250 may further be converted and represented in a visual format, such as image or other media formats, e.g., in accordance with visualization module 290. In one example, the visualization module 290 may utilize one or more additional generative AI/ML models, such as a text-to-image trained MLM, or the like. It should be noted that the foregoing is just one example architecture of a system 200 for presenting in response to a query a textual output of a generative machine learning model trained using network operational data that is transformed into a text-based format and just one example of a generative MLM-based communication network knowledge platform 210. Thus, other, further, and different examples may have a different form in accordance with the present disclosure. For instance, the use of external tools 265 and/or internal tools 260 may be omitted, alternative or additional pre- or post-processing operations may be performed, and so forth. Thus, these and other modifications are all contemplated within the scope of the present disclosure.

As noted above, one of the practical results of a generative MLM of the present disclosure is network-protocol language comprehension. For instance, in data communication networks, protocols serve as a common language for devices/systems to communicate irrespective of differences in software, hardware, or internal processes. A large communication network may collect and process a substantial volume of data generated by devices/systems following such protocols. In one example, by clustering/grouping data from a collection of data sources for each well-defined end-to-end communication, the present disclosure may construct sentences that describe how devices/systems are communicating in the underlying network. For instance, each sentence may comprise a sequence of messages filled in with different information that can be converted to text or other media formats. Accordingly, a generative MLM of the present disclosure may learn the structure/grammar of the underlying sentences that can be used for different applications. Note that, the end-to-end communications can be defined for different segments of the network. For example, an end-to-end communication can be defined on a radio access network (RAN) side from a user equipment (UE) to the base station (eNB/gNB), from the UE to the transport or core-network, between the transport/core network and the Internet, from UE to UE, etc.

As an illustrative example, consider a communication between a UE and an eNB in a Long Term Evolution (LTE) environment where, following the 3^{rd} Generation Partnership Project (3GPP) protocol(s) (and after completing a cell selection procedure), the communication may be commenced by sending a “RRC Connection Request” message/signal from the UE to the eNB. The communication may then proceed with a set of other messages such as “RRC Connection Setup,” “RRC Connection Reconfiguration,” etc. Each of these messages may contain multiple fields, such as: timestamp, the identity of the UE, the identity of the eNB, parametric values (e.g., a cause-code, a result-code, etc.), and so forth. This sequence of messages, and the internal fields of such messages, can be converted to text to build a sentence indicating how the end-to-end communication has been established and accomplished. For example, using information received from multiple events, a sentence can be composed as the following: “At 2:45 pm, UE X requested a connection to eNB Y. UE X received connection setup at 2:45:12 pm and the RRC connection setup completed with normal cause code at 2:45:17 . . . . The UE X has capability of category-4. It received M bytes of information during 23 seconds and the connection was released at 2:47:39 with normal cause-code.” In another example, for each UE, the sequence of events/messages can be ordered in time to form a “sentence” (or paragraph) as a time-series. For example, for a give UE communication, a sequence of messages may comprise: RRC-connection-request, RRC-configuration-setup, RRC-reconfiguration-complete, RRC-connection-reconfiguration, RRC-connection-complete.

Using substantial volumes of network operational data, and by composing a large number of sentences, the structure/grammar and the content of these sentences can be learned by a generative MLM of the present disclosure, and consequently can be used for a variety of applications, such as for different classification/regression applications, predictive/inference analysis, root-cause identification, question/answering, summarization, and so forth. Note that, each sentence can be composed of a set of messages, and information within messages, for sets of different combinations of devices in the communication network (e.g., UE, cell, eNB/gNB, etc.). In addition, in one example, multiple sentences can be combined in different ways to compose longer network speech parts for training of the generative MLM. In one example, a communication network may maintain cell and other network-device/system configurations in databases or files. For example, cell configuration parameters may be stored in a database with columns as in the example Table 1:

TABLE 1

| | | | | Gain | | |
|---|---|---|---|---|---|---|
| Date/Time | Cell ID | Freq. | Band | (dB) | Beamwidth | Lat./Long |
| Jul. 9, 2022 | 12345-98 | 735 | 17 | 10 | 60 | 37.678,- |
| | | | | | | 121.456 |
| | . . . | . . . | . . . | . . . | . . . | . . . |

In this case, each row of Table 1 can be converted to text form and inserted as pure text into a generative MLM (e.g., an LLM-based AI/ML model) of the present disclosure. For example, the first row shown in Table 1 can be converted to the following text: “On Jul. 7th 2022, the cell with identity 12345-98 was operating at downlink frequency 735 mega hertz which is in band 17. The gain of the antenna is 10 dB and its beamwidth is 60 degrees. This cell is located in Modesto California.” In one example, categorical variables, such as Cell-ID, can be converted into numerical values or other formats e.g., using predefined rules/templates that may be tailored to specific categories of data. In addition, in one example, numerical values can be converted into pure text. For example, 123 can be converted to “one hundred and twenty three” or 34.453 can be converted to “thirty-four and four hundreds fifty-three thousandths.”

It should also be noted that a large communication network may possess different network management, monitoring, and operational tools that may be used for different purposes, such as network troubleshooting and optimization. The resulting information may similarly be stored in databases or files. For example, the follow example Table 2 may comprise data gathered from running quality check (QC) tests for different customers and at different times:

TABLE 2

| | | RR1 (poor | RR2 (2G | RR4 (5G | |
|---|---|---|---|---|---|
| Date/Time | Cust. ID | WiFi) | disabled) | disabled) | . . . |
| Jan. 12, 2023 | 12345 | Yes | No | Yes | . . . |
| | . . . | . . . | . . . | . . . | . . . |

Similar to the above, each row of Table 2 can be converted to text and inserted as pure text into a generative MLM (e.g., an LLM-based AI/ML model) of the present disclosure. For example, the first row illustrated in Table 2 can be converted to the following text: “On Jan. 12th 2023, the customer ID 12345, with a 5 GHz enabled device, experienced a poor wireless coverage.” By converting this data to text, the generative MLM can directly use this data, along with other text data, to self-configure. The generative MLM may then be used for different applications such as technician dispatch prediction, network anomaly detection and alerting, and so forth. Note that, identifiers (IDs) such as customer IDs, can be converted to synthetic/fake names or strings as well.

In another example, Table 3 may comprise eNodeB/gNodeB event reports, as follows:

TABLE 3

| Timestamp | IMSI | Global cell ID | RSRP | RSRQ |
|---|---|---|---|---|
| 2023:08:07 | 123456789 | 98765-12 | −87 | −8 |
| 15:45:00 | | | | |
| . . . | . . . | . . . | . . . | . . . |

The first row shown in Table 3 may comprise an RRC Measurement Report event. Similar to the above, each row of Table 3 can be converted to text and inserted as pure text into a generative MLM (e.g., an LLM-based AI/ML model) of the present disclosure. For example, the first row illustrated in Table 3 can be converted to the following text: “On Monday Aug. 7, 2023 at 3.45 in the afternoon, User 123456789 in cell 98765-12, experiences a good RSRP.” Here, the numeric values of RSRP=−87 may be converted to quantitative value “good” by applying thresholding techniques (e.g., an rule from a rule-based algorithm) where, for example, −90<=RSRP <=−80 dBm may be categorized as “good.” In one example, the quantitative values for a device in the network, for example RSRPs for a cell in LTE/5G network in a day, can be converted to heatmap images or the like, where the generative MLM may use heatmaps and/or other images in training and prediction. It should also be noted that an eNodeB/gNodeB event report log may contain millions of rows/records/reports per day. Thus, for illustrative purposes, only a single row of the example Table 3 is presented herein.

The present example may be extended to additional combinations of different events and/or data-sources. For example, consider the following Table 4:

TABLE 4

| | | Global cell | | | |
|---|---|---|---|---|---|
| Timestamp | IMSI | ID | eNB name | RSRP | RSRQ |
| 2023:08:07 | 1 | 2 | 1 | −87 | −8 |
| 15:45:00 | | | | | |
| 2023:08:07 | 1 | 2 | 1 | −88 | −9 |
| 15:55:00 | | | | | |
| 2023:08:07 | 1 | 2 | 1 | −78 | −7 |
| 16:15:00 | | | | | |
| 2023:08:07 | 1 | 2 | 1 | −85 | −8 |
| 16:30:00 | | | | | |
| . . . | . . . | . . . | . . . | . . . | . . . |

In one example, the illustrated rows of the example Table 4 may be converted/transformed to text as follows: (1) “On Monday Aug. 7, 2023 at 3.45 in the afternoon, User1 in cell 2, which is a cell of eNodeB1, experiences a good rsrp.,” (2) “On Monday Aug. 7, 2023 at 3.55 in the afternoon, User1 in cell 2, which is a cell of eNodeB1, experiences a good rsrp.,” (3) “On Monday Aug. 7, 2023 at 4.15 in the afternoon, User1 in cell 2, which is a cell of eNodeB1, experiences an excellent rsrp.,” (4) “On Monday Aug. 7, 2023 at 4.30 in the afternoon, User1 in cell 2, which is a cell of eNodeB1, experiences a good rsrp.” Continuing with the present example, a generative MLM of the present disclosure may also be trained with data from a variety of internal and/or external documents from one or more network knowledge repositories. For example, the following text/sentences/passages may be extracted from one or more such documents: (1) “Reference Signal Received Power (RSRP) is a measure of the received power level in an LTE cell network. The average power is a measure of the power received from a single reference signal.,” (2) “Users very close to BS that experiencing RSRP greater than or equal to −80 dBm have excellent reception.,” (3) “Users close to BS that experiencing RSRP less than or equal to −80 dBm and greater than or equal to −90 dBm have good reception.,” (4) “Users experiencing RSRP less than or equal to −90 dBm and greater than or equal to −100 dBm are at the Mid Cell.,” (5) “Users experiencing RSRP less than or equal to −100 dBm are at the cell edge.”

In one example, after training (e.g., and after fine tuning) a generative MLM of the present disclosure with a volume of such training data, the following query may be input to the generative MLM: “What RSRP did UE 1 experience on Monday Aug. 7, 2023 at 4.00 in the afternoon?.” The following answer/result may be generated and provided as an output by the generative MLM: “On Monday Aug. 7, 2023 at 4.00 in the afternoon, User1 in cell 2 experiences a good rsrp in the range of [−90, −80] and it is close to the BS.” Note that in this example, the answer may be highly accurate for a stationary user.

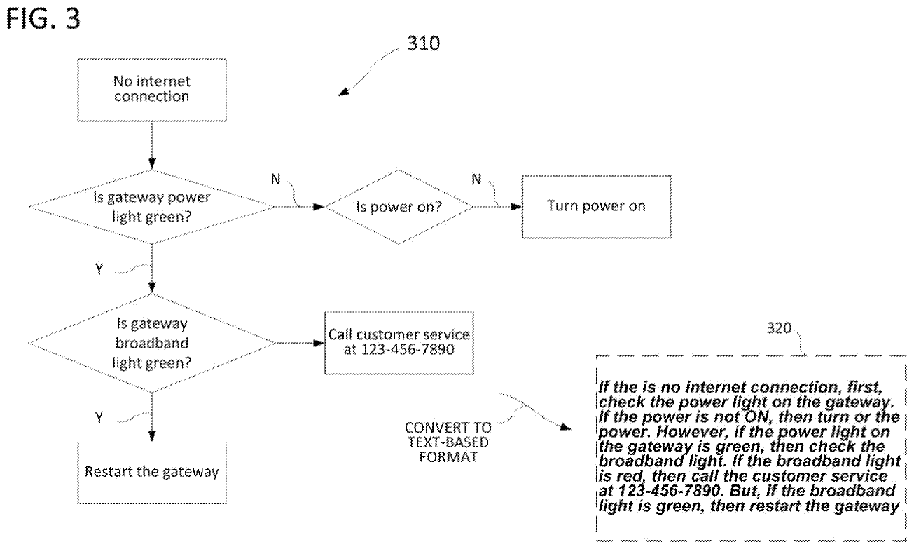

As noted above, a communication network may also possess a substantial knowledge base in the form of flowcharts for various network management, operations, troubleshooting, optimization, and other processes. In one example, such flowcharts can also be converted to text-based format and used by the generative MLM directly as additional training data to improve performance/accuracy in different applications, such as for a question/answer use case where a more precise set of actions can be recommended for a given resolution. For example, FIG. 3 illustrates an example flowchart 310 that can be converted to the following text (labeled 320 in FIG. 3) and used for training a generative MLM of the present disclosure: “If the is no internet connection, first, check the power light on the gateway. If the power is not ON, then turn or the power. However, if the power light on the gateway is green, then check the broadband light. If the broadband light is red, then call the customer service at 123-456-7890. But, if the broadband light is green, then restart the gateway.”

FIG. 4 illustrates a flowchart of an example method 400 for presenting in response to a query a textual output of a generative machine learning model trained using network operational data that is transformed into a text-based format. In one example, steps, functions, and/or operations of the method 400 may be performed by a device as illustrated in FIG. 1, e.g., one or more of the servers 135, or the like, and/or by device or system as illustrated in FIG. 2, such as generative MLM-based communication network knowledge platform 210. Alternatively, or in addition, the steps, functions and/or operations of the method 400 may be performed by a processing system collectively comprising a plurality of devices as illustrated in FIG. 1 such as one or more of the servers 135, DB(s) 136, endpoint devices 111-113 and/or 121-123 (e.g., user equipment (UE), or the like), and so forth. In one example, the steps, functions, or operations of method 400 may be performed by a computing device or system 500, and/or a processing system 502 as described in connection with FIG. 5 below. For instance, the computing device 500 may represent at least a portion of a platform, a server, a system, and so forth, in accordance with the present disclosure. For illustrative purposes, the method 400 is described in greater detail below in connection with an example performed by a processing system. The method 400 begins in step 405 and proceeds to step 410.

At step 410, the processing system may obtain network operational data of a communication network. For example, the network operational data may comprise the network operational data 220 described above in connection with the example of FIG. 2, or elsewhere herein. For instance, the network operational data may comprise network performance indicator data (e.g., “KPIs” or other measurements self-reported by devices/systems or measured by other entities within the communication network) or configurable setting values for one or more network settings (e.g., antenna tilt, beamwidth, transmit power, compute resources allocated to a VM (e.g., max processor availability, max memory allocated to the VM, etc.), a class/quality label assigned to a device, customer, customer premises, and/or particular traffic thereof, etc.).

At step 415, the processing system transforms the network operational data into a text-based format. For instance, step 415 may include the operations of the data-to-media format conversion module 240 of FIG. 2, or as described elsewhere herein. For instance, the transforming of the network operational data into the text-based format may be in accordance with at least a first AI model that is configured to transform the network operational data into the text-based format. For example, the at least the first AI model may comprise at least a first machine learning model (MLM) that is trained to transform the network operational data into the text-based format. In one example, the at least the first MLM may be trained separately from a primary generative MLM implemented by the processing system. In another example, the at least the first MLM may be trained along with the primary generative MLM, e.g., based upon user feedback or other objective criteria over which the system as a whole may be optimized. Alternatively, or in addition, in one example, the at least the first AI model may include one or more rule-based algorithms to convert tabular data or the like into text format. In one example, the processing system may implement different conversion rules for different types of data. As noted above, in one example, the at least the first AI model may be one of a plurality of AI models capable of transforming the network operational data into the text-based format. In such an example, step 415 may include selecting the at least the first AI model from among the plurality of AI models based upon one or more performance optimization criteria of the primary generative MLM implemented by the processing system (as described in greater detail below, e.g., in connection with step 440). For example, the processing system may monitor which AI model(s) for the transforming of the network operational data into the text-based format that provides the “best” performance of the generative MLM that is subsequently trained with the transformed data, e.g., in terms of speed, accuracy, operational cost, energy utilization in connection with the compute load, etc. and/or a weighted combination of any of the foregoing. In one example, the performance optimization may alternatively or additionally be based upon user feedback of whether result is “good” or “bad,” high, medium, or low quality, etc.

In one example, step 415 may include converting categorical data to a numeric encoding and transforming the numeric encoding into the text-based format. To illustrate, the processing system may identify at least one categorical variable in the network operational data and may adjust at least one setting of the first AI model to maintain values of the at least one categorical value in a non-transformed format based upon one or more performance optimization criteria of the generative MLM. For instance, if a customer ID is a random string of characters and numbers, it may be useful to not convert 1234AB to “one thousand two hundred and thirty four A B,” since there may be nothing within this snippet that may be relevant to a predicting task (e.g., predicting the next word in an output text sequence, or the like). For instance, it makes no difference if the customer ID is alternatively 2234AB, which may be represented as “two thousand two hundred and thirty four A B.” This may prevent the primary generative MLM to be trained with such data from placing undue weight upon the fact that a first text may contain “one thousand” while the other may contain “two thousand.” In one example, on the output side, the processing system may convert a portion of a text-based format output to the numeric encoding, and then may convert back into an appropriate categorical value, e.g., according to a key table that may be maintained for this purpose.

At optional step 420, the processing system may apply an anonymization process to the network operational data in the text-based format to remove personal information and/or sensitive information. For instance, the anonymization process may replace personal information with a generic token (e.g., the name of a user “John Smith” may be replaced by “a user in category 7B,” or the like). The anonymization process may be the same or similar as described above in connection with post-processing 245 of the example generative MLM-based communication network knowledge platform 210 of FIG. 2.

At optional step 425, the processing system may obtain a plurality of documents from at least one network knowledge repository, e.g., technical documentation associated with network operations, such as documents with subject matter about network management, troubleshooting, device/system manuals, network configuration and deployment, network maintenance, etc. The documentation may include whitepapers, books, lecture notes, etc. In one example, the documents may be included from one or more selected network knowledge repositories. In one example, documents may be selected using one or more selection criteria, such as being published or otherwise dated within the last 10 years, having more than a threshold number of words, having certain keywords and/or a threshold number of instances of the selected keyword(s), and so forth.

At optional step 430, the processing system may obtain flowchart data from the at least one network knowledge repository (e.g., flowchart data from a plurality of flowcharts containing network knowledge, procedures, etc.).

At optional step 435, the processing system may transform the flowchart data into the text-based format. For instance, aspects of optional step 435 may be same or similar as described above in connection with the example flowchart 310 of FIG. 3.

At step 440, the processing system trains a generative MLM (e.g., the primary generative MLM) implemented by the processing system using the network operational data in the text-based format. In one example, the training may further comprise training the generative MLM implemented by the processing system using the plurality of documents that may be obtained at optional step 425. Similarly, in one example, the training of step 440 may further comprise training the generative MLM implemented by the processing system using the flowchart data in the text-based format that may be created at optional step 435. In one example, the generative MLM may comprise a deep neural network-based model. For instance, the generative MLM may comprise a transformer-based language model, e.g., a large language model (LLM) or the like. It should be noted that the training may include various stages including hyperparameter tuning/optimization, fine tuning, feature engineering (e.g., selection of the AI model(s) for converting network operational data to text based format, parameter tuning of such AI model(s), etc.), and/or as further described above in connection with the generative MLM 250 of FIG. 2.

At step 445, the processing system receives a query pertaining to the network operational data. As noted above, in one example, the query may be from a user. In another example, the query may be from another automated system. In one example, the query can be a recurring or periodic query, e.g., “report any anomalies in network zone H11,” “provide hourly summary reports on cell site 12345,” etc. As further noted above, in various examples, the query may comprise a classification request, a summarization request, a question pertaining to the network operational data, a forecasting request, an anomaly detection request, a network setting recommendation request, or the like.

At step 450, the processing system applies the query to the generative MLM implemented by the processing system to generate a textual output in response to the query. For instance, the generative MLM may be trained to process queries of one or more types and to provide text-based/textual output that is responsive to the query (e.g., responsive to the particular type of query and the expected type of output, as well as being accurate with respect to the specific data requested and/or accurate with respect to the available network operational data used for training and that is informative of the textual output).

At optional step 455, the processing system may convert the textual output to a different media format. For instance, the processing system may convert the textual output to an audio output, e.g., via a text-to-speech conversion algorithm, may utilize one or more additional generative AI/ML models, such as a text-to-image trained MLM, or the like to generate an image representing the textual output, and so forth.

At step 460, the processing system presents the textual output that is generated in response to the query. In one example, the presenting may comprise presenting the textual output in the different media format that may be created at optional step 455 (e.g., as an alternative or in addition to the text-based format as output directly from the generative MLM). In one example, step 460 may include transmitting the textual output to an endpoint device of a user submitting the query or to another automated system that may have submitted the query (and/or to another automated system or user/endpoint device designated by the user or automated system submitting the query). For instance, in one example, step 460 may include providing recommendations to a software defined network (SDN) controller, which may send instructions to one or more network elements and/or customer devices to configure/re-configure in accordance with a recommendation contained in the textual output.

At optional step 465, the processing system may obtain feedback on the textual output, e.g., from a user or other automated system. For instance, as noted above, the user may indicate a perceived quality of the result, such as “good,” “acceptable,” “poor,” or the like. Alternatively, or in addition, the feedback may include objective measures. For instance, where the textual output comprises a network setting recommendation that is then implemented, performance indicators (e.g., KPIs, or the like) can be measured after the fact to assess whether the recommended network setting(s) resulted in improved or stable performance, worse performance, etc. In still another example, the feedback may comprise an operator correction of the textual output. For instance, in response to a user identification of “poor” or “unacceptable” output, network personnel may manually investigate the relevant underlying data (e.g., subject to permissions, privacy and security guardrails, etc.) to identify what a proper response may or should look like. A corrected or suggested proper output may then be fed-back to the generative MLM as part of retraining.

At optional step 470, the processing system may retrain the generative MLM using the feedback that is obtained. In this regard, it should again be noted that in one example, the processing system may implement a reinforcement learning process in connection with/as part of the example method 400.

Following step 460, and/or following optional step 470, the method 400 ends in step 495. It should be noted that method 400 may be expanded to include additional steps, or may be modified to replace steps with different steps, to combine steps, to omit steps, to perform steps in a different order, and so forth. For instance, in one example, the processing system may repeat one or more steps of the method 400, such as steps 410-440 for new/additional network operational data, flowchart data, and/or auxiliary documents on an ongoing basis (e.g., periodically or otherwise), may repeat steps 445-460 for additional queries, may repeat steps 410-470 for retraining based on ongoing feedback and new/additional network operational data, flowchart data, auxiliary documents, etc., and so forth. In one example, the anonymization of optional step 420 may precede step 415. Alternatively, or in addition, the method 400 may include other pre- or post-processing operations, such as ETL operations, data cleansing, sanitizing, averaging, etc. In one example, the method 400 may include automatically adjusting one or more network settings (e.g., configurable setting(s)/parameter(s)) in response to the textual output that is presented. For instance, the textual output may comprise a set of RAN settings to implement at an eNodeB/gNodeB. In one example, the method 400 may include verifying/benchmarking the textual output vis-a-via one or more other MLMs, e.g., another proprietary MLM of the communication network operator or a general-purpose LLM that is not specifically trained with network operational data, but which may have access to and which may be trained at least in part using publicly available technical documents. In one example, a confidence score may be provided by the processing system based upon a level of matching (e.g., cosine similarity, etc.) between the textual output of the generative MLM implemented by the processing system and the outputs of one or more other generative MLMs in response to the same query. In one example, the benchmarking and confidence scoring may follow step 450. In one example, the benchmarking and confidence scoring may be included in optional step 465. In one example, the method 400 may be expanded or modified to include conversion of the network operational data to another media format (e.g., a chart/image generated from table-based data, an animation showing a time series data progression, etc.), e.g., at step 415, and training a generative MLM at step 440 to generate new image, animation, or similar visual output. For instance, in such an example, an output responsive to a query for predicting network load at a future time period may be an animation that is output via the generative MLM that is so trained. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the method 400 may include a storing, displaying, and/or outputting step as required for a particular application. In other words, any data, records, fields, and/or intermediate results discussed in the method 400 can be stored, displayed and/or outputted either on the device executing the method 400, or to another device, as required for a particular application. Furthermore, steps, blocks, functions, or operations in FIG. 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 500 may comprise optional steps, or can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIGS. 1 and 2, or described in connection with the examples of FIGS. 3 and 4 may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for presenting in response to a query a textual output of a generative machine learning model trained using network operational data that is transformed into a text-based format, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 5, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 5 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for presenting in response to a query a textual output of a generative machine learning model trained using network operational data that is transformed into a text-based format (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for presenting in response to a query a textual output of a generative machine learning model trained using network operational data that is transformed into a text-based format (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

1. A method comprising:
obtaining, by a processing system including at least one processor, network operational data of a communication network;
transforming, by the processing system, the network operational data into a text-based format;
training, by the processing system, a generative machine learning model implemented by the processing system using the network operational data in the text-based format, wherein the generative machine learning model comprises a deep neural network language model;
receiving, by the processing system, a query pertaining to the network operational data;
applying, by the processing system, the query to the generative machine learning model implemented by the processing system to generate a textual output in response to the query; and
presenting, by the processing system, the textual output that is generated in response to the query.

2. The method of claim 1, wherein the network operational data comprises at least one of:
network performance indicator data; or
configurable setting values for one or more network settings.

3. The method of claim 1, further comprising:
obtaining a plurality of documents from at least one network knowledge repository, wherein the training further comprises training the generative machine learning model implemented by the processing system using the plurality of documents.

4. The method of claim 1, further comprising:
obtaining flowchart data from at least one network knowledge repository; and
transforming the flowchart data into the text-based format, wherein the training further comprises training the generative machine learning model implemented by the processing system using the flowchart data in the text-based format.

5. The method of claim 1, further comprising:
applying an anonymization process to the network operational data in the text-based format to remove personal information and sensitive information.

6. The method of claim 5, wherein the anonymization process replaces personal information with a generic token.

7. The method of claim 1, wherein the transforming of the network operational data into the text-based format is in accordance with at least a first artificial intelligence model that is configured to transform the network operational data into the text-based format.

8. The method of claim 7, wherein the at least the first artificial intelligence model comprises at least a first machine learning model that is trained to transform the network operational data into the text-based format.

9. The method of claim 7, wherein the at least the first artificial intelligence model is one of a plurality of artificial intelligence models capable of transforming the network operational data into the text-based format, wherein the transforming of the network operational data into the text-based format further comprises:
selecting the at least the first artificial intelligence model from among the plurality of artificial intelligence models based upon a performance optimization criterion of the generative machine learning model.

10. The method of claim 1, wherein the transforming comprises:
converting categorical data to a numeric encoding; and
transforming the numeric encoding into the text-based format.

11. The method of claim 1, wherein the query pertaining to the network operational data comprises:
a classification request;
a summarization request;
a question pertaining to the network operational data;
a prediction and forecasting request;
an anomaly detection and root-cause analysis request; or
a network setting recommendation request.

12. The method of claim 1, further comprising:
obtaining, by the processing system, feedback on the textual output; and
retraining, by the processing system, the generative machine learning model using the feedback that is obtained.

13. The method of claim 12, wherein the feedback includes a measure of correspondence between the textual output and one or more outputs of one or more additional generative machine learning models that are internal or external to the communication network.

14. The method of claim 1, wherein the presenting of the textual output that is generated in response to the query comprises:
applying an anonymization process to the textual output to remove personal information.

15. The method of claim 1, further comprising
converting, by the processing system, the textual output to a different media format, wherein the presenting comprises presenting the textual output in the different media format.

16. The method of claim 15, wherein the different media format is selected by a user from among a plurality of available media formats.

17. (canceled)

18. The method of claim 1, wherein the deep neural network language model comprises at least one of:
a large language model; or
a transformer-based language model.

19. A non-transitory computer-readable medium storing instructions which, when executed by a processing system including at least one processor, cause the processing system to perform operations, the operations comprising:
obtaining network operational data of a communication network;
transforming the network operational data into a text-based format;
training a generative machine learning model implemented by the processing system using the network operational data in the text-based format, wherein the generative machine learning model comprises a deep neural network language model;
receiving a query pertaining to the network operational data;
applying the query to the generative machine learning model implemented by the processing system to generate a textual output in response to the query; and
presenting the textual output that is generated in response to the query.

20. An apparatus comprising:
a processing system including at least one processor; and
a computer-readable medium storing instructions which, when executed by the processing system, cause the processing system to perform operations, the operations comprising:
obtaining network operational data of a communication network;
transforming the network operational data into a text-based format;
training a generative machine learning model implemented by the processing system using the network operational data in the text-based format, wherein the generative machine learning model comprises a deep neural network language model;
receiving a query pertaining to the network operational data;
applying the query to the generative machine learning model implemented by the processing system to generate a textual output in response to the query; and
presenting the textual output that is generated in response to the query.

21. The apparatus of claim 20, wherein the network operational data comprises at least one of:
network performance indicator data; or
configurable setting values for one or more network settings.
